(19) United States
(12) Patent Application Publication
(10) Pub. No.: US 2023/0420726 A1
(43) Pub. Date: Dec. 28, 2023

(54) ELECTROCHEMICAL DEVICE

(71) Applicant: Panasonic Intellectual Property Management Co., Ltd., Osaka (JP)

(72) Inventors: YUSUKE NAKAMURA, Osaka (JP); YUJI SONODA, Kyoto (JP); YASUYUKI ITO, Osaka (JP)

(21) Appl. No.: 18/246,290

(22) PCT Filed: Oct. 26, 2021
(86) PCT No.: PCT/JP2021/039383

§ 371 Date: Mar. 22, 2023

(30) Foreign Application Priority Data
Oct. 27, 2020 (JP) 2020-179931

(51) Int. Cl. H01M 10/0525; H01M 4/66

(52) U.S. Cl. CPC H01M 10/0525; H01M 2004/027; H01M 4/663

(57) ABSTRACT

An electrochemical device includes: an electrode body including a positive electrode, a negative electrode, and a separator disposed between the positive electrode and the negative electrode; and an electrolyte containing a lithium salt. The negative electrode includes a negative current collector and a negative electrode mixture layer supported on the negative current collector. The negative electrode mixture layer contains a negative electrode active material that is reversibly doped with lithium ions, and the negative current collector has substantially no through-hole. A specific surface area of the negative electrode mixture layer is in a range from 30 m²/g to 60 m²/g, inclusive, and in a discharged state, a potential of the negative electrode is less than or equal to 0.2 V with respect to a Li counter electrode.

### TECHNICAL FIELD

The present invention relates to an electrochemical device.

### BACKGROUND

In recent years, electrochemical devices in which the electricity storage principle of a lithium ion secondary battery and the electricity storage principle of electric double layer capacitor are combined have attracted attention. Such electrochemical devices typically use a polarizable electrode for a positive electrode and a non-polarizable electrode for a negative electrode. As a result, the electrochemical devices are expected to have both the high energy density of a lithium ion secondary battery and the high output characteristic of an electric double layer capacitor.

PTL 1 proposes a negative electrode coating film of a lithium ion capacitor. The negative electrode coating film is obtained by applying, on a metal foil, a coating composition containing non-graphitizable carbon, a conductive additive, and a binder in an aqueous medium containing a dispersant, and heating and drying the coating composition. The conductive additive is at least one of Ketjenblack, acetylene black, and graphite. The particle size distribution of constituent particles in the negative electrode coating film shows a D₁₀ particle size of more than or equal to 0.5 μm, a D₅₀ particle size in the range from 1 μm to 4 μm, inclusive, and a D₉₀ particle size of less than or equal to 8 μm. The specific surface area of the negative electrode coating film is in the range from 1.5 m²/g to 25 m²/g, inclusive, and the surface roughness of the negative electrode coating film is in the range from 0.1 μm to 0.3 μm, inclusive.

### CITATION LIST

### Patent Literature

PTL 1: Unexamined Japanese Patent Publication No. 2010-98020

### SUMMARY

However, to achieve both a high capacitance and a high output characteristic of the electrochemical devices as described above at higher levels, further improvement is needed.

One aspect of the present invention relates to an electrochemical device including an electrode body and an electrolyte containing a lithium salt. The electrode body includes a positive electrode, a negative electrode, and a separator disposed between the positive electrode and the negative electrode. The negative electrode includes a negative current collector and a negative electrode mixture layer supported on the negative current collector. The negative electrode mixture layer contains a negative electrode active material that is reversibly doped with lithium ions, and the negative current collector has substantially no through-hole. A specific surface area of the negative electrode mixture layer is in range from 30 m²/g to 60 m²/g, inclusive, and in a discharged state, a potential of the negative electrode is less than or equal to 0.2 V with respect to a Li counter electrode.

According to the present invention, it is possible to provide an electrochemical device that achieves both a high capacitance and a high output characteristic.

### BRIEF DESCRIPTION OF THE DRAWINGS

FIG. 1 is a longitudinal sectional view illustrating an electrochemical device according to an exemplary embodiment of the present invention.

### DESCRIPTION OF EMBODIMENT

An electrochemical device according to an exemplary embodiment of the present invention includes an electrode body and an electrolyte containing a lithium salt. The electrode body includes a positive electrode, a negative electrode, and a separator disposed between the positive electrode and the negative electrode. The electrode body is configured as, for example, a columnar wound body in which a band-shaped positive electrode and a band-shaped negative electrode are wound with a separator interposed therebetween. The electrode body may also be configured as a stacked body in which a plate-shaped positive electrode and a plate-shaped negative electrode are stacked with a separator interposed therebetween.

The negative electrode includes a negative current collector and a negative electrode mixture layer supported on the negative current collector. The negative electrode mixture layer contains a negative electrode active material that is reversibly doped with lithium ions. In the negative electrode, the Faraday reaction in which lithium ions are reversibly occluded and released proceeds to develop a capacitance. The doping of the negative electrode active material with lithium ions means a concept that includes at least an occlusion phenomenon of lithium ions into the negative electrode active material and may include adsorption of lithium ions to the negative electrode active material and chemical interaction between the negative electrode active material and lithium ions.

The potential of the negative electrode increases along with discharge. In the case of a normal lithium ion secondary battery, in the fully discharged state, the potential of the negative electrode is, for example, 1 V with respect to a Li counter electrode and exceeds 0.2 V. On the other hand, in the electrochemical device of the present exemplary embodiment, the potential of the negative electrode is less than or equal to 0.2 V with respect to the Li counter electrode in the discharged state. This means that the negative electrode is doped with sufficient lithium even in the discharged state. Such a negative electrode is obtained by pre-doping the negative electrode with lithium ions in advance before charging the manufactured device. By using the pre-doped negative electrode, a high capacitance can be realized.

Here, the discharged state means a state in which an electrochemical device charged at a constant current with a current density of 2 mA/cm² per positive electrode area under an environment of 25° C. until the voltage reaches a voltage (for example, 3.8 V) corresponding to a SOC of more than or equal to 95% is discharged at a constant current with a current density of 2 mA/cm² per positive electrode area under an environment of 25° C. until the voltage reaches a voltage (for example, 2.2 V) corresponding to a depth of discharge (DOD) of more than or equal to 95%. The potential of the negative electrode is determined by disassembling the device after charging and discharging under the above conditions, assembling a half cell with the extracted negative electrode as a working electrode and a Li metal foil as a counter electrode, and measuring the potential of the negative electrode with respect to the Li metal foil.

An electrochemical device including a negative electrode pre-doped with lithium ions is different from a general lithium ion secondary battery in that rapid charge and rapid discharge are possible and that high output is possible. In order to enable rapid charge and rapid discharge and obtain high output, a foil having a through-hole for improving liquid spread of an electrolyte is generally used as a negative current collector of an electrochemical device. However, by providing the through-hole, resistance by the current collector increases, and high output may not be obtained. In the case where a foil having a through-hole is used, there is a limit of enhancement of output characteristics.

In addition, in the case where a foil having a through-hole is used, the strength of the foil is reduced, and the foil may be broken by tensile stress. In particular, in the case where a wound body in which a positive electrode and a negative electrode are wound with a separator interposed therebetween is used as the electrode body, the wound body expands (and contracts) along with charging and discharging, and at this time, tensile stress (and compressive stress) is applied to the current collector. As a result, the current collector having the through-hole is easily broken. In order to suppress breakage of the current collector having the through-hole, reduce resistance, and obtain high output, a conceivable measure is to increase the thickness of the current collector. However, in the case where the thickness of the current collector is increased, the thickness of the negative electrode mixture layer is reduced accordingly, or in the case where the thickness of the negative electrode mixture layer is not changed, the area of the negative electrode is reduced. As a result, it is difficult to obtain a high capacitance.

In the electrochemical device of the present exemplary embodiment, a negative current collector having substantially no through-hole is used. This makes it possible to suppress an increase in resistance, to obtain high output, to secure the strength of the negative current collector, and to suppress breakage of the wound body associated with charging and discharging. Furthermore, since the negative current collector can be thinned while ensuring the strength of the negative current collector, it is possible to easily increase the thickness of the negative electrode mixture layer or increase the area of the negative electrode, and a high capacitance can be easily realized by a synergistic effect with the use of the pre-doped negative electrode. The negative current collector having substantially no through-hole means that the opening ratio of the negative current collector is, for example, less than or equal to 1%. The opening ratio of the negative current collector means the ratio of the area of the opening portion present in the main surface to the area of the main surface of the negative current collector.

In addition, in the electrochemical device of the present exemplary embodiment, the specific surface area of the negative electrode mixture layer is more than or equal to 30 m²/g. As a result, higher output can be realized. The specific surface area of the negative electrode mixture layer is more preferably more than or equal to 40 m²/g. On the other hand, from the viewpoint of suppressing an increase in side reactions and maintaining high cycle characteristics, the specific surface area of the negative electrode mixture layer is less than or equal to 60 m²/g, more preferably less than or equal to 50 m²/g.

The specific surface area of the negative electrode mixture layer is adjusted to a desired value by changing the negative electrode active material, the materials and characteristics (such as particle diameter and specific surface area) of the binding agent and the conductive additive that can be contained in the negative electrode active material, the blending ratio, and the like. The conductive additive may have a specific surface area of more than or equal to 800 m²/g. Accordingly, it is easy to form a negative electrode mixture layer having a desired specific surface area. The specific surface area of the conductive additive is more preferably from 800 m²/g to 1,500 m²/g, inclusive.

The specific surface area of the negative electrode mixture layer is a BET specific surface area determined using a measurement apparatus in accordance with JIS Z 8830 (for example, TriStar II 3020 manufactured by Shimadzu Corporation). Specifically, the electrochemical device is disassembled, and the negative electrode is taken out. A half cell is assembled using the negative electrode as a working electrode and a Li metal foil as a counter electrode, and the negative electrode is dedoped with Li until the negative electrode potential reaches 1.5 V. Next, the negative electrode dedoped with Li is washed with dimethyl carbonate (DMC) and dried. Thereafter, the negative electrode mixture layer is peeled off from the negative current collector, and about 0.5 g of a sample of the negative electrode mixture layer is collected.

Next, the collected sample is heated at 150° C. for 12 hours under a reduced pressure of less than or equal to 95 kPa, and thereafter, nitrogen gas is adsorbed to the sample whose mass is known to obtain an adsorption isotherm at a relative pressure in the range from 0 to 1, inclusive. Then, the surface area of the sample is calculated from the monolayer adsorption capacity of the gas obtained from the adsorption isotherm. Here, the specific surface area is determined from the following BET formula by the single-point BET method (relative pressure 0.3).

P/V(P0−P)=(1/VmC)+{(C−1)NmC}(P/P0) (1)

S=kVm (2)
P0: saturated vapor pressure
P: adsorption equilibrium pressure
V: adsorption amount at adsorption equilibrium pressure P
Vm: monolayer adsorption capacity
C: parameter related to heat of adsorption and the like
S: specific surface area
k: area occupied by single nitrogen molecule, which is 0.162 nm²

In the case where the negative electrode mixture layer contains a conductive additive, the content proportion of the conductive additive in the negative electrode mixture layer is preferably from 3 by mass to 15% by mass, inclusive, more preferably from 5% by mass to 10% by mass, inclusive. When the content proportion of the conductive additive is more than or equal to 3% by mass, the resistance of the negative electrode mixture layer is reduced, and the current collection property is improved. As a result, higher output can be realized. On the other hand, when the content proportion of the conductive additive is excessive, the proportion of the negative electrode active material in the negative electrode mixture layer decreases, and a high capacitance may not be obtained. In addition, as the specific surface area of the negative electrode mixture layer increases, side reactions may increase, leading to deterioration of cycle characteristics. From the viewpoint of maintaining a high capacitance and high cycle characteristics, the content proportion of the conductive additive is preferably less than or equal to 15% by mass or less than or equal to 10% by mass.

The content proportion of the conductive additive is determined for the conductive additive separated from the negative electrode mixture layer by the following method. The electrochemical device is disassembled to take out the negative electrode, and a part of the negative electrode mixture layer is peeled off from the negative electrode dedoped with Li by the above-described method. The negative electrode mixture layer is washed with water to remove the binding agent and the like, and then the conductive additive is separated by centrifugation. The content proportion of the conductive additive is a ratio of the mass of the conductive additive after separation to the mass of the negative electrode mixture layer before washed with water.

The specific surface area of the conductive additive is determined by the BET method in the same manner as for the specific surface area of the negative electrode mixture layer for the conductive additive separated by the above method.

The negative electrode active material preferably contains non-graphitizable carbon. Non-graphitizable carbon is also called hard carbon. By using hard carbon, high cycle characteristics can be obtained even under charge and discharge conditions where rapid charge and rapid discharge are repeated. In this case, the negative electrode mixture layer preferably contains carbon black as the conductive additive. Carbon black has a large specific surface area and easily increases the specific surface area of the negative electrode mixture layer. Further, since carbon black easily covers hard carbon, the binding property between particles of the negative electrode active material is easily improved.

The thickness of the negative current collector may be less than or equal to 15 μm. As described above, in the electrochemical device of the present exemplary embodiment, since the opening ratio of the negative current collector is small, the strength can be maintained even when the thickness of the negative current collector is reduced. A high capacitance can be realized by increasing the thickness of the negative electrode mixture layer instead of decreasing the thickness of the negative current collector. The thickness of the negative current collector is preferably less than or equal to 10 μm, more preferably less than or equal to 8 μm. On the other hand, when the thickness of the negative current collector is reduced, the resistance increases, and high output may not be obtained. To maintain high output, the thickness of the negative current collector is preferably more than or equal to 3 μm, more preferably more than or equal to 4 μm. The upper limits and the lower limits of the above thickness may have any combination.

The thickness of the negative electrode mixture layer may be, for example, more than or equal to 25 μm, more than or equal to 30 μm, or more than or equal to 32 μm. In the above description, the thickness of the negative electrode mixture layer means the thickness on one side in the case where negative electrode mixture layers are formed on both sides of the negative current collector.

The positive electrode includes a positive current collector and a positive electrode mixture layer supported on the positive current collector. The positive electrode mixture layer contains a positive electrode active material that is reversibly doped with an anion. When an anion is adsorbed to the positive electrode active material, an electric double layer forms to develop a capacitance. The positive electrode may be a polarizable electrode or may be an electrode that has the properties of a polarizable electrode and in which the Faraday reaction also contributes to the capacitance.

The positive electrode active material may be a carbon material or a conductive polymer. The doping of the positive electrode active material with the anion means a concept that includes at least an adsorption phenomenon of the anion to the positive electrode active material and may include occlusion of the anion by the positive electrode active material and chemical interaction between the positive electrode active material and the anion.

The pre-doping of the negative electrode with lithium ions may be performed by bringing the negative electrode into contact with an electrolyte having lithium ion conductivity before assembling the device. As a lithium ion source used for the pre-doping, for example, metal lithium may be used. For example, a working electrode (such as a metal plate made of SUS) to which a negative electrode and the lithium ion source are attached is put into a battery container filled with an electrolyte having lithium ion conductivity in the state where a separator is interposed between the negative electrode and the working electrode, and a voltage is applied between the positive electrode and the negative electrode using the working electrode as a positive electrode, whereby pre-doping can be performed. The application of the voltage can be performed, for example, under a condition that a predetermined constant current flows between the positive electrode and the negative electrode. The voltage application time is, for example, from 1 hour to 75 hours, inclusive.

Metal lithium as the lithium ion source may be attached to the surface of the negative electrode mixture layer in advance, the negative electrode to which metal lithium is attached may be put into the battery container, and a voltage may be applied between the negative electrode and the working electrode to perform pre-doping.

Metal lithium can be attached to the surface of the negative electrode mixture layer by, for example, a gas phase method, transfer, or the like. Examples of the gas phase method include chemical vapor deposition, physical vapor deposition, and sputtering. For example, metal lithium may be formed into a film on the surface of the negative electrode mixture layer with a vacuum vapor deposition apparatus. The pressure in a chamber of the apparatus during vapor deposition may be, for example, from 10⁻² Pa to 10⁻⁵ Pa, inclusive, the temperature of a lithium evaporation source may be from 400° C. to 600° C., inclusive, and the temperature of the negative electrode mixture layer may be from −20° C. to 80° C., inclusive.

A layer (first layer) containing lithium carbonate can be formed on a surface layer part of the negative electrode mixture layer by exposing the negative electrode having the negative electrode mixture layer to which metal lithium is attached to a carbon dioxide gas atmosphere. The layer containing lithium carbonate can have an action of suppressing deterioration of the negative electrode and suppressing an increase in low-temperature DCR of the electrochemical device as described later. The carbon dioxide gas atmosphere is preferably a dry atmosphere that does not contain moisture and may have, for example, a dew point of less than or equal to −40° C. or less than or equal to −50° C. The carbon dioxide gas atmosphere may contain gases other than carbon dioxide, but the molar fraction of carbon dioxide is preferably more than or equal to 80%, more preferably more than or equal to 95%. It is desirable that the carbon dioxide gas atmosphere does not contain an oxidizing gas, and the molar fraction of oxygen may be less than or equal to 0.1%. It is efficient that the partial pressure of carbon dioxide in the carbon dioxide gas atmosphere is greater than, for example, 0.5 atm (5.05×10⁴ Pa) and may be more than or equal to 1 atm (1.01×10⁵ Pa).

By bringing the negative electrode into contact with an electrolyte having lithium ion conductivity, pre-doping with lithium ions can be performed, and a layer (second layer) containing a solid electrolyte can be formed on a surface layer part of the negative electrode. The second layer acts as a solid electrolyte interface coating film (that is, an SEI coating film). In the case where the first layer is formed on the surface layer part of the negative electrode mixture layer, the second layer can be formed so as to cover at least a part of the first layer. The first layer containing lithium carbonate has an action of promoting formation of a favorable SEI coating film and maintaining the SEI coating film in a favorable state when charging and discharging are repeated.

Hereinafter, the positive electrode and the negative electrode may be collectively referred to as electrodes. The positive current collector and the negative current collector may be collectively referred to as current collectors (or electrode current collectors). The positive electrode mixture layer and the negative electrode mixture layer may be collectively referred to as mixture layers (or electrode mixture layers). The positive electrode active material and the negative electrode active material may be collectively referred to as active materials (or electrode active materials).

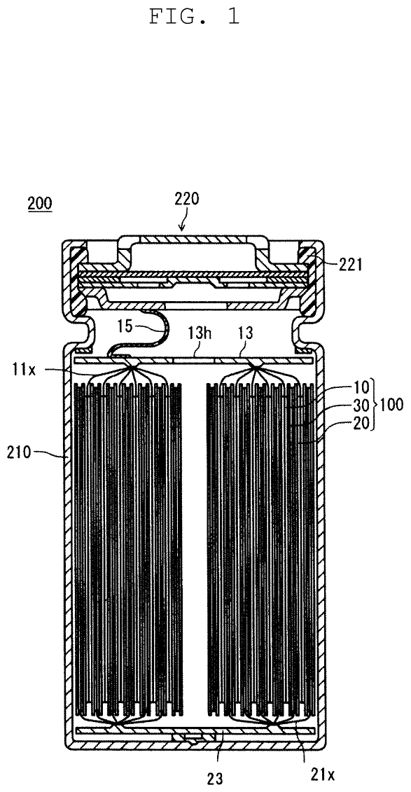

FIG. 1 schematically illustrates the configuration of electrochemical device 200 according to an exemplary embodiment of the present invention. Electrochemical device 200 includes electrode body 100, a nonaqueous electrolyte (not illustrated), bottomed cell case 210 made of metal, which accommodates electrode body 100 and the nonaqueous electrolyte, and sealing plate 220 that seals an opening of cell case 210. Gasket 221 is provided on the peripheral edge of sealing plate 220, and the open end of cell case 210 is crimped with gasket 221, whereby the inside of cell case 210 is sealed. Positive current collection plate 13 having through-hole 13h at the center is welded to positive current collector exposed part 11x. The other end of tab lead 15 having one end connected to positive current collection plate 13 is connected to an inner surface of sealing plate 220. Thus, sealing plate 220 has a function as an external positive electrode terminal. On the other hand, negative current collection plate 23 is welded to negative current collector exposed part 21x. Negative current collection plate 23 is directly welded to a welding member provided on the inner bottom surface of cell case 210. Thus, cell case 210 has a function as an external negative electrode terminal.

Hereinafter, each component of the electrochemical device according to the exemplary embodiment of the present invention will be described in more detail.

### (Negative Electrode)

The negative electrode includes a negative current collector and a negative electrode mixture layer supported on the negative current collector. The negative electrode mixture layer contains a negative electrode active material that is reversibly doped with lithium ions. The negative electrode active material contains non-graphitizable carbon (that is, hard carbon). The thickness of the negative electrode mixture layer is, for example, from 10 μm to 300 μm, inclusive, per surface of the negative current collector. The thickness of the negative electrode mixture layer may be more than or equal to 25 μm per surface of the negative current collector.

As the negative current collector, a sheet-shaped metallic material having substantially no through-hole is used. Examples of the sheet-shaped metallic material include a metal foil. As the metallic material, copper, a copper alloy, nickel, stainless steel, or the like may be used. The opening ratio of the negative current collector may be less than or equal to 1%.

The negative current collection plate is a metal plate having a substantially disk shape. The material of the negative current collection plate is, for example, copper, a copper alloy, nickel, stainless steel, or the like. The material of the negative current collection plate may be the same as the material of the negative current collector.

The non-graphitizable carbon may have an interplanar spacing d002 (that is, the interplanar spacing between a carbon layer and a carbon layer) of the (002) plane of more than or equal to 3.8 Å as measured by an X-ray diffraction method. The theoretical capacity of the non-graphitizable carbon is desirably, for example, more than or equal to 150 mAh/g. By using non-graphitizable carbon, a negative electrode having a small low-temperature DCR and small expansion and contraction accompanying charging and discharging is likely to be obtained. The non-graphitizable carbon desirably accounts for more than or equal to 50% by mass, further, more than or equal to 80% by mass, and further, more than or equal to 95% by mass of the negative electrode active material. The non-graphitizable carbon desirably accounts for more than or equal to 40% by mass, further, more than or equal to 70% by mass, and further, more than or equal to 90% by mass of the negative electrode mixture layer.

As the negative electrode active material, non-graphitizable carbon and a material other than non-graphitizable carbon may be used in combination. Examples of the material other than non-graphitizable carbon that may be used as the negative electrode active material include graphitizable carbon (soft carbon), graphite (natural graphite, artificial graphite, and the like), lithium titanium oxide (spinel type lithium titanium oxide or the like), silicon oxide, silicon alloys, tin oxide, and tin alloys.

The average particle diameter of the negative electrode active material (in particular, non-graphitizable carbon) is preferably in the range from 1 μm to 20 μm, inclusive, more preferably in the range from 2 μm to 15 μm, inclusive, from the viewpoint of a high filling property of the negative electrode active material in the negative electrode and easy inhibition of side reactions with the electrolyte.

In the present specification, the average particle diameter means a volume-based median diameter (D₅₀) in a particle size distribution obtained by laser diffraction type particle size distribution measurement.

The negative electrode mixture layer contains the negative electrode active material as an essential component and contains the conductive additive, a binding agent, and the like as optional components. Examples of the conductive additive include carbon black and carbon fiber. The conductive additive preferably contains carbon black. Examples of the binding agent include a fluorine resin, an acrylic resin, a rubber material, and a cellulose derivative.

The negative electrode mixture layer is formed, for example, by mixing a negative electrode active material, a conductive agent, a binding agent, and the like together with a dispersion medium to prepare a negative electrode mixture slurry, applying the negative electrode mixture slurry to the negative current collector, and then drying the negative electrode mixture slurry.

The negative electrode mixture layer is pre-doped with lithium ions. This doping decreases the potential of the negative electrode and thus increases a difference in potential (that is, voltage) between the positive electrode and the negative electrode and improves energy density of the electrochemical device. The amount of lithium to be pre-doped may be, for example, in the range from about 50% to 95%, inclusive, with respect to the maximum amount that can be occluded in the negative electrode mixture layer.

The electrostatic capacity per unit mass of the negative electrode active material may be, for example, more than or equal 1,000 F/g. From the viewpoint of increasing the capacitance density of the electrochemical device, the electrostatic capacity per unit mass of the negative electrode active material may be, for example, less than or equal to 30,000 F/g. The electrostatic capacity per unit mass of the negative electrode active material is usually greater than the electrostatic capacity per unit mass of the positive electrode active material and is, for example, from 20 times to 800 times, inclusive, the electrostatic capacity per unit mass of the positive electrode active material. The electrostatic capacity per unit mass of the negative electrode active material may be measured by the following method.

First, a negative electrode for evaluation cut into a size of 31 mm×41 mm is prepared. As a counter electrode of the negative electrode, a metal lithium foil cut into a size of 40 mm×50 mm and having a thickness of 100 μm is prepared. A negative electrode mixture layer and the metal lithium foil are opposed to each other with a cellulose paper manufactured by NIPPON KODOSHI CORPORATION (for example, product number TF4425) having a thickness of 25 μm interposed therebetween as a separator to form an electrode body, and the electrode body is immersed in an electrolyte of Example 1 described later to assemble a cell.

The cell is charged at a constant current (CC) of 0.5 mA until the cell voltage reaches 0.01 V, then charged at a constant voltage (CV) for 1 hour, and then discharged at 0.5 mA until the cell voltage reaches 1.5 V. The electrostatic capacity per unit mass of the negative electrode active material is determined from the discharge time during a potential change of 0.1 V from the potential of the negative electrode 1 minute after the start of discharging.

The surface layer part of the negative electrode mixture layer may have a first layer containing lithium carbonate as a constituent element of the coating film. The first layer is mainly formed on the surface of the negative electrode active material. The negative electrode is more likely to deteriorate as the specific surface area of the negative electrode mixture layer increases, but the deterioration of the negative electrode is remarkably inhibited by forming the first layer. The deterioration of the negative electrode is typically evaluated as an increase rate of the low-temperature DCR of the electrochemical device when float charging is performed at a high temperature by applying a constant voltage to the electrochemical device using an external DC power supply.

The surface layer part of the negative electrode may have a second layer containing a solid electrolyte as a constituent element of the coating film. The second layer has a composition different from that of the first layer, and the second layer is distinguishable from the first layer. In an electrochemical device using lithium ions, a solid electrolyte interface coating film (that is, an SEI coating film) is formed on the negative electrode mixture layer during charging and discharging. The second layer may be formed as the SEI coating film. The SEI coating film serves an important function in charge-discharge reaction, but an excessively thick SEI coating film causes the negative electrode to greatly deteriorate. On the other hand, the first layer containing lithium carbonate has an action of promoting formation of a favorable SEI coating film and maintaining the SEI coating film in a favorable state when charging and discharging are repeated. Thus, formation of the first layer on the surface layer part of the negative electrode mixture layer enables the negative electrode to be remarkably inhibited from deteriorating even in the case where the specific surface area of the negative electrode mixture layer is increased to obtain high output.

When the coating film has the first layer and the second layer, at least a part of the second layer covers at least a part of the surface of the negative electrode active material with the first layer interposed therebetween. That is, at least a part of the first layer is covered with the second layer. The first layer is interposed between the surface of the negative electrode active material and the second layer and serves as an underlayer of the second layer. The first layer serving as an underlayer causes the second layer to be formed as an SEI coating film in a favorable state.

The second layer may also contain lithium carbonate. When the second layer contains lithium carbonate, the content proportion of lithium carbonate in the second layer is smaller than the content proportion of lithium carbonate in the first layer. It is a necessary condition that the first layer containing a large amount of lithium carbonate is used as an underlayer for the second layer to be formed as an SEI coating film in a favorable state.

The first layer is formed on the surface layer part of the negative electrode mixture layer before the electrochemical device is assembled. In the electrochemical device assembled using the negative electrode, the second layer (SEI coating film) having a uniform and appropriate thickness is formed on the surface of the negative electrode active material by subsequent charging and discharging. The SEI coating film is formed, for example, by a reaction between an electrolyte and the negative electrode in the electrochemical device. Since the electrolyte can pass through not only the second layer but also the first layer, the entire surface layer part including the first layer and the second layer may be referred to as the SEI coating film, but in the present specification, the second layer is referred to as the SEI coating film and distinguished from the first layer for convenience.

The presence of a region containing lithium carbonate such as the first layer may be confirmed by, for example, analysis of the surface layer part by X-ray photoelectron spectroscopy (XPS). The analysis method is not limited to XPS.

The thickness of the first layer may be, for example, more than or equal to 1 nm, may be more than or equal to 5 nm when a longer-term action is expected, and may be more than or equal to 10 nm when a more reliable action is expected. When the thickness of the first layer exceeds 50 nm, the first layer itself may be a resistance component. Thus, the thickness of the first layer may be less than or equal to 50 nm or may be less than or equal to 30 nm.

The thickness of the second layer is, for example, more than or equal to 1 nm or may be more than or equal to 3 nm. It is sufficient that the thickness thereof is more than or equal to 5 nm. When the thickness of the second layer exceeds 20 nm, the second layer itself may be a resistance component. Thus, the thickness of the second layer may be less than or equal to 20 nm or may be less than or equal to 10 nm.

The ratio A/B between thickness A of the first layer and thickness B of the second layer is preferably less than or equal to 1 from the viewpoint of reducing the initial low-temperature DCR. At this time, the thickness of the second layer is preferably less than or equal to 20 nm and may be less than or equal to 10 nm. However, from the viewpoint of forming the second layer in a favorable state, A/B is desirably more than or equal to 0.1, and for example, the A/B ratio may be more than or equal to 0.2.

The thicknesses of the first layer and the second layer are measured by analyzing the surface layer part of the negative electrode mixture layer at a plurality of locations (at least five locations) of the negative electrode mixture layer. Then, the average of the thickness of the first layer or second layer obtained at the plurality of locations may be set as the thickness of the first layer or second layer. The negative electrode mixture layer used as the measurement sample may be peeled off from the negative current collector. In this case, the coating film formed on the surface of the negative electrode active material constituting the vicinity of the surface layer part of the negative electrode mixture layer may be analyzed. Specifically, the negative electrode active material covered with the coating film may be collected from a region of the negative electrode mixture layer disposed on the surface opposite to the surface joined to the negative current collector and used for analysis.

In the XPS analysis of the surface layer part of the negative electrode mixture layer, for example, the surface layer part or the coating film formed on the surface of the negative electrode active material is irradiated with an argon beam in a chamber of an X-ray photoelectron spectrometer, and changes in each spectrum attributed to C1s, O1s electrons, and the like with respect to the irradiation time are observed and recorded. At this time, from the viewpoint of avoiding analysis error, the spectrum of the outermost surface of the surface layer part may be ignored. The thickness of the region where the peak attributed to lithium carbonate is stably observed corresponds to the thickness of the first layer.

In the case of a negative electrode taken out from an electrochemical device after completion and predetermined aging or at least one charging and discharging, the surface layer part of the negative electrode mixture layer has an SEI coating film (that is, the second layer) containing a solid electrolyte. The thickness of the region where the peak attributed to the bond of a compound contained in the SEI coating film is stably observed corresponds to the thickness of the SEI coating film (that is, the thickness of the second layer).

As the compound contained in the SEI coating film, a compound containing an element that may be a label of the second layer is selected. As the element that may be a label of the second layer, for example, an element that is contained in the electrolyte and is substantially not contained in the first layer (for example, F) may be selected. As the compound containing an element that may be a label of the second layer, for example, LiF may be selected.

When the second layer contains LiF, a substantial F1s peak attributed to the LiF bond is observed when the second layer is measured by X-ray photoelectron spectroscopy. In this case, the thickness of the region where the peak attributed to the LiF bond is stably observed corresponds to the thickness of the second layer.

On the other hand, the first layer usually does not contain LiF, and a substantial peak of F1s attributed to the LiF bond is not observed even when the first layer is measured by X-ray photoelectron spectroscopy. Thus, the thickness of the region where the peak attributed to the LiF bond is not stably observed may be used as the thickness of the first layer.

In the SEI coating film, O1s peaks attributed to lithium carbonate may also be observed. Meanwhile, since the SEI coating film generated in the electrochemical device has a composition different from that of the first layer formed in advance, the SEI coating film and the first layer can be distinguished from each other. For example, in the XPS analysis of the SEI coating film, an F1s peak attributed to the LiF bond is observed, but a substantial F1s peak attributed to the LiF bond is not observed in the first layer. In addition, the amount of lithium carbonate contained in the SEI coating film is very small. As the Li1s peak, a peak derived from a compound such as ROCO₂Li or ROLi may be detected, for example.

When the first layer is analyzed by XPS, a second peak of O1s attributed to the Li—O bond may be observed in addition to the first peak of O1s attributed to the C═O bond. The region of the coating film present in the vicinity of the surface of the negative electrode active material may contain a slight amount of LiOH or Li₂O.

Specifically, when the first layer constituting the surface layer part of the negative electrode mixture layer is analyzed in a depth direction, a first region, in which a first peak (O1s attributed to the C═O bond) and a second peak (O1s attributed to the Li—O bond) are observed and a first peak intensity is larger than a second peak intensity, and a second region, in which the first peak and the second peak are observed and the second peak intensity is larger than the first peak intensity, may be observed in the order of increasing the distance from the outermost surface of the surface layer part. A third region in which the first peak is observed and the second peak is not observed may further be present, the third region being located closer to the outermost surface of the surface layer part than the first region. The third region is likely to be observed when the thickness of the lithium carbonate-containing region is large.

The magnitude of the peak intensity may be determined by the height of the peak from the baseline.

At the center in the thickness direction of the first layer, usually, the C1s peak attributed to the C—C bond is not substantially observed, or even when observed, the C1s peak is half or less of the peak intensity attributed to the C═O bond.

Next, a method for forming the first layer containing lithium carbonate on the surface layer part of the negative electrode mixture layer will be described. The step of forming the first layer may be performed by, for example, a gas phase method, a coating method, transfer, or the like.

Examples of the gas phase method include chemical vapor deposition, physical vapor deposition, and sputtering. For example, lithium carbonate may be attached to the surface of the negative electrode mixture layer with a vacuum vapor deposition apparatus. The pressure in a chamber of the apparatus during vapor deposition may be, for example, from 10⁻² Pa to 10⁻⁵ Pa, inclusive, the temperature of a lithium carbonate evaporation source may be from 400° C. to 600° C., inclusive, and the temperature of the negative electrode mixture layer may be from −20° C. to 80° C., inclusive.

As the coating method, the first layer may be formed by coating a solution or dispersion containing lithium carbonate on a surface of the negative electrode using, for example, a microgravure coater and drying the solution or dispersion. The content proportion of lithium carbonate in the solution or dispersion is, for example, from 0.3% by mass to 2% by mass, inclusive, and when a solution is used, the content proportion of lithium carbonate may be a concentration less than or equal to the solubility (for example, from about 0.9% by mass to 1.3% by mass, inclusive, in the case of an aqueous solution at normal temperature).

Further, the negative electrode may be obtained by performing a step of forming the second layer containing a solid electrolyte so as to cover at least a part of the first layer. The surface layer part of the obtained negative electrode mixture layer has the first layer and the second layer. The second layer is formed such that at least a part of the second layer covers at least a part (preferably the whole) of the surface of the negative electrode active material with the first layer interposed therebetween (that is, the first layer is used as an underlayer).

The step of forming the second layer is promoted by bringing the negative electrode mixture layer and the electrolyte into contact with each other and is then completed by leaving the product for a predetermined time. For example, the second layer may be formed on the negative electrode mixture layer by performing at least one charging and discharging on the electrochemical device. The step of forming the second layer may serve as at least a part of a step of pre-doping the negative electrode mixture layer with lithium ions.

It is desirable that the step of forming the first layer is performed before the electrode body is formed, but performing this step after the electrode body is formed is not excluded.

### (Positive Electrode)

The positive electrode includes the positive current collector and the positive electrode mixture layer supported on the positive current collector. The positive electrode mixture layer contains the positive electrode active material that is reversibly doped with an anion. The positive electrode active material is, for example, a carbon material, a conductive polymer, or the like. The thickness of the positive electrode mixture layer is, for example, from 10 μm to 300 μm, inclusive, per surface of the positive current collector.

A sheet-shaped metallic material is used as the positive current collector. The sheet-shaped metallic material may be a metal foil, a porous metal body, an etched metal, or the like. As the metallic material, aluminum, an aluminum alloy, nickel, titanium, or the like may be used. Similarly to the negative current collector, the positive current collector is preferably a sheet material having substantially no through-hole.

The positive current collection plate is a metal plate having a substantially disk shape. It is preferable to form a through-hole serving as a passage for the nonaqueous electrolyte in the center of the positive current collection plate. The material of the positive current collection plate is, for example, aluminum, an aluminum alloy, titanium, stainless steel, or the like. The material of the positive current collection plate may be the same as the material of the positive current collector.

As the carbon material used as the positive electrode active material, a porous carbon material is preferable. For example, activated carbon or a carbon material exemplified as the negative electrode active material (for example, non-graphitizable carbon) is preferable. Examples of the raw material of activated carbon include wood, coconut shell, coal, pitch, and phenol resin. The activated carbon is preferably subjected to an activation treatment.

The average particle diameter of the activated carbon is not particularly limited and is preferably less than or equal to 20 μm, more preferably in the range from 3 μm to 15 μm, inclusive.

The specific surface area of the positive electrode mixture layer roughly reflects the specific surface area of the positive electrode active material. The specific surface area of the positive electrode mixture layer is, for example, from 600 m²/g to 4,000 m²/g, inclusive, and is desirably from 800 m²/g to 3,000 m²/g, inclusive. The specific surface area of the positive electrode mixture layer is a BET specific surface area determined using a measurement apparatus in accordance with JIS Z 8830 (for example, TriStar II 3020 manufactured by Shimadzu Corporation). Specifically, the electrochemical device is disassembled, and the positive electrode is taken out. Next, the positive electrode is washed with DMC and dried. Thereafter, the positive electrode mixture layer is peeled off from the positive current collector, and about 0.5 g of a sample of the positive electrode mixture layer is collected. Next, the specific surface area of the collected sample is determined according to the method for measuring the specific surface area of the negative electrode mixture layer described above.

The activated carbon desirably accounts for more than or equal to 50% by mass, further, more than or equal to 80% by mass, and further, more than or equal to 95% by mass of the positive electrode active material. The activated carbon desirably accounts for more than or equal to 40% by mass, further, more than or equal to 70% by mass, and further, more than or equal to 90% by mass of the positive electrode mixture layer.

The positive electrode mixture layer contains the positive electrode active material as an essential component and contains the conductive additive, a binding agent, and the like as optional components. Examples of the conductive additive include carbon black and carbon fiber. Examples of the binding agent include a fluorine resin, an acrylic resin, a rubber material, and a cellulose derivative.

The positive electrode mixture layer is formed by, for example, mixing the positive electrode active material, the conductive agent, the binding agent, and the like with a dispersion medium to prepare a positive electrode mixture slurry, applying the positive electrode mixture slurry to the positive current collector, and thereafter drying the positive electrode mixture slurry.

The conductive polymer used as the positive electrode active material is preferably a π-conjugated polymer. As the π-conjugated polymer, for example, polypyrrole, polythiophene, polyfuran, polyaniline, poly(thiophene vinylene), polypyridine, or a derivative of these polymers may be used. These materials may be used alone or in combination of two or more. The weight-average molecular weight of the conductive polymer is, for example, from 1,000 to 100,000, inclusive. The derivative of the π-conjugated polymer means a polymer having, as a basic skeleton, a π-conjugated polymer such as polypyrrole, polythiophene, polyfuran, polyaniline, poly(thiophene vinylene), or polypyridine. For example, a polythiophene derivative includes poly(3,4-ethylenedioxythiophene) (PEDOT).

The conductive polymer is formed by, for example, immersing a positive current collector including a carbon layer in a reaction solution containing a raw material monomer of the conductive polymer, and electrolytically polymerizing the raw material monomer in the presence of the positive current collector. In the electrolytic polymerization, the positive current collector and a counter electrode may be immersed in a reaction solution containing a raw material monomer, and a current may be caused to flow between them with the positive current collector as an anode. The conductive polymer may be formed by a method other than electrolytic polymerization. For example, the conductive polymer may be formed by chemical polymerization of a raw material monomer. In the chemical polymerization, the raw material monomer may be polymerized with an oxidizing agent or the like in the presence of the positive current collector.

The raw material monomer used in electrolytic polymerization or chemical polymerization may be any polymerizable compound capable of producing the conductive polymer by polymerization. The raw material monomer may contain an oligomer. Examples of the raw material monomer that may be used include aniline, pyrrole, thiophene, furan, thiophene vinylene, pyridine, or a derivative of these monomers. These materials may be used alone or in combination of two or more. Among them, aniline is likely to grow on the surface of a carbon layer by electrolytic polymerization.

Electrolytic polymerization or chemical polymerization may be carried out using a reaction solution containing an anion (dopant). Excellent conductivity is exhibited by doping the π-electron conjugated polymer with a dopant. Examples of the dopant include a sulfate ion, a nitrate ion, a phosphate ion, a borate ion, a benzenesulfonate ion, a naphthalenesulfonate ion, a toluenesulfonate ion, a methanesulfonate ion, a perchlorate ion, a tetrafluoroborate ion, a hexafluorophosphate ion, and a fluorosulfate ion. The dopant may be a polymer ion. Examples of the polymer ion include ions of polyvinylsulfonic acid, poly styrenesulfonic acid, polyallylsulfonic acid, polyacryl sulfonic acid, polymethacryl sulfonic acid, poly(2-acrylamido-2-methylpropanesulfonic acid), polyisoprenesulfonic acid, and polyacrylic acid.

### (Separator)

As the separator, a nonwoven fabric made of cellulose fiber, a nonwoven fabric made of glass fiber, a microporous film, woven fabric, or nonwoven fabric made of polyolefin, or the like may be used. The thickness of the separator is, for example, from 8 μm to 300 μm, inclusive, preferably from 8 μm to 40 μm, inclusive.

### (Electrolyte)

The electrolyte has lithium ion conductivity and contains, for example, a lithium salt and a solvent that dissolves the lithium salt. The positive electrode is repeatedly and reversibly doped and dedoped with the lithium salt anion. Lithium ions derived from the lithium salt are reversibly occluded in and released from the negative electrode.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. These materials may be used alone or in combination of two or more. Among them, a salt having a fluorine-containing anion is preferable, and in particular, lithium bis(fluorosulfonyl)imide, that is, LiN(SO₂F)₂ is preferably used. The concentration of the lithium salt in the electrolyte in a charged state (charging rate (SOC) from 90% to 100%, inclusive) is, for example, from 0.2 mol/L to 5 mol/L, inclusive. Hereinafter, LiN(SO₂F)₂ is referred to as LiFSI. For example, more than or equal to 80% by mass of the lithium salt may be LiFSI.

The increase rate of the low-temperature DCR tends to be remarkably decreased by using LiFSI. It is considered that LiFSI has an effect of reducing deterioration of the positive electrode active material and the negative electrode active material. Among salts having a fluorine-containing anion, the FSI anion is considered to be excellent in stability, so that it is less likely to generate by-products but smoothly contribute to charging and discharging without damaging the surface of the active materials. In particular, when the capacity of the positive electrode is increased and the specific surface area of the negative electrode mixture layer is increased, a remarkable effect of inhibiting deterioration (effect of inhibiting an increase in low-temperature DCR) is obtained by using LiFSI with which the influence of by-products on each active material is remarkably reduced.

Examples of the solvent that may be used include: cyclic carbonates such as ethylene carbonate, propylene carbonate, and butylene carbonate; chain carbonates such as dimethyl carbonate, diethyl carbonate, and ethyl methyl carbonate; aliphatic carboxylate esters such as methyl formate, methyl acetate, methyl propionate, and ethyl propionate; lactones such as γ-butyrolactone and γ-valerolactone; chain ethers such as 1,2-dimethoxyethane (DME), 1,2-diethoxyethane (DEE), and ethoxymethoxyethane (EME); cyclic ethers such as tetrahydrofuran and 2-methyltetrahydrofuran; dimethyl sulfoxide; 1,3-dioxolane; formamide; acetamide; dimethylformamide; dioxolane; acetonitrile; propionitrile; nitromethane; ethylmonoglyme; trimethoxymethane; sulfolane; methylsulfolane; and 1,3-propane sultone. These materials may be used alone or in combination of two or more.

The electrolyte may contain various additive agents as necessary. For example, an unsaturated carbonate such as vinylene carbonate, vinylethylene carbonate, and divinylethylene carbonate may be added as an additive agent for forming a lithium ion conductive coating film on the surface of the negative electrode.

### EXAMPLE

Hereinafter, the present invention will be described in more detail by way of examples, but the present invention is not limited to examples. The outline of the configuration of each device produced below is shown in Table 1.

### (Device A1)

### (1) Production of Positive Electrode

An aluminum foil (positive current collector) having a thickness of 30 μm was prepared. Activated carbon (average particle diameter: 5.5 μm) in an amount of 88 parts by mass as a positive electrode active material, 6 parts by mass of polytetrafluoroethylene as a binding material, and 6 parts by mass of acetylene black as a conductive material were dispersed in water to prepare a positive electrode mixture slurry. The obtained positive electrode mixture slurry was applied to both surfaces of the aluminum foil, the coating film was dried, and the obtained material was rolled to form a positive electrode mixture layer, whereby a positive electrode was obtained. A positive current collector exposed part having a width of 10 mm was formed at an end part along a longitudinal direction of the positive current collector.

### (2) Production of Negative Electrode

A copper foil (negative current collector) having a thickness of 8 μm was prepared. As the copper foil, a copper foil having no through-hole was prepared. Non-graphitizable carbon (average particle diameter: 5 μm) in an amount of 94 parts by mass, 1 part by mass of carboxycellulose, and 5 parts by mass of carbon black were dispersed in water to prepare a negative electrode mixture slurry. Carbon black having a BET specific surface area of 800 m²/g was used. The obtained negative electrode mixture slurry was applied to both surfaces of the copper foil, the coating film was dried, and the obtained material was rolled to form a negative electrode mixture layer, whereby a negative electrode was obtained. The thickness of the negative electrode mixture layer was 32 μm on one side.

For the obtained negative electrode, the BET surface area of the negative electrode mixture layer was measured by the method described above and found to be 40 m²/g.

Thereafter, the negative electrode was charged into a battery container filled with an electrolyte having lithium ion conductivity. Similarly, a SUS metal plate carrying metal lithium as a working electrode was put into the battery container, and a voltage was applied between the negative electrode and the working electrode in a state in which a separator was interposed between the negative electrode and the working electrode. Using the positive electrode as a working electrode, the cell was charged at a constant current (CC) of 0.1 mA until the cell voltage reaches 0.01 V and then charged at a constant voltage (CV) for 5 hours, whereby pre-doping was performed. As a solvent of the electrolyte, a solvent obtained by adding 1% by mass of vinylene carbonate (VC) to a solvent obtained by mixing ethylene carbonate (EC), ethyl methyl carbonate (EMC), and diethyl carbonate (DEC) at a volume ratio of 1:2:7 was used. LiPF₆ as a lithium salt was added to the mixed solvent at a concentration of 1.2 mol/L to prepare an electrolyte. After completion of the pre-doping, the negative electrode was washed with dimethyl carbonate (DEC) to obtain a negative electrode pre-doped with lithium ions.

### (3) Production of Electrode Body

An electrode body was formed by winding the positive electrode and the negative electrode in a columnar shape with a cellulose nonwoven fabric separator (with a thickness of 25 μm) interposed therebetween. At this time, the positive current collector exposed part was projected from one end surface of the wound body, and the negative current collector exposed part was projected from the other end surface of the electrode body. A disk-shaped positive current collection plate and a disk-shaped negative current collection plate were welded to the positive current collector exposed part and the negative current collector exposed part, respectively.

### (4) Preparation of Nonaqueous Electrolytic Solution

A solvent was prepared by adding 0.2% by mass of vinylene carbonate to a mixture of propylene carbonate and dimethyl carbonate in a volume ratio of 1:1. LiF SI was dissolved as a lithium salt in the obtained solvent at a concentration of 1.2 mol/L to prepare a nonaqueous electrolyte.

### (5) Assembly of Electrochemical Device

The electrode body was housed in a bottomed cell case with an opening, the tab lead connected to the positive current collection plate was connected to the inner surface of the sealing plate, and the negative current collection plate was welded to the inner bottom surface of the cell case. The nonaqueous electrolyte was put into the cell case, and then, the opening of the cell case was closed with the sealing plate. An electrochemical device as illustrated in FIG. 1 was thus assembled.

Thereafter, aging was performed at 60° C. while a charge voltage of 3.8 V was applied between terminals of the positive electrode and the negative electrode to complete pre-doping of the negative electrode with lithium ions.

### (6) Evaluation

### [Evaluation 1: Measurement of Capacitance (Energy Density) of Electrochemical Device]

Initial charging and discharging was performed under the following conditions.

The electrochemical device immediately after aging was subjected to constant current charging at a current density of 2 mA/cm² per positive electrode area under an environment of 25° C. until the voltage reached 3.8 V, and then a state in which the voltage of 3.8 V was applied was maintained for 10 minutes. Thereafter, under an environment of 25° C., constant current discharging was performed at a current density of 2 mA/cm² per positive electrode area until the voltage reached 2.2 V. Time t (sec) required for the voltage to drop from 3.3 V to 3.0 V in the discharging was measured. Initial capacitance C₁ of the electrochemical device was determined from formula (A) shown below using measured time t.

Capacitance C₁=Id×t/V (A)

In formula (A), Id is a current value (current density per positive electrode area: 2 mA/cm²×positive electrode area) at the time of discharging, and V is a value (0.3 V) obtained by subtracting 3.0 V from 3.3 V.

On the basis of capacitance C₁, energy density E (Wh/L) of the electrochemical device was evaluated by following formula (B). In formula (B), V₁ is an upper limit voltage (3.8 V) in charge and discharge, and V₂ is a lower limit voltage (2.2 V). The volume occupied by the device is represented by V_{CELL}.

E=(½)×C1×(V₁²−V₂²)/(3600×V_{CELL}) (B)

### [Evaluation 2: Measurement of Power Density of Electrochemical Device]

Next, using the discharge curve (vertical axis: discharge voltage, horizontal axis: discharge time) obtained by the above discharging, a first-order approximate straight line in the range from 0.5 seconds to 2 seconds, inclusive, after the start of discharging of the discharge curve was obtained, and voltage VS (voltage at 0 seconds after the start of discharge) which is a voltage at an intercept of the approximate straight line was obtained. A value (V0-VS) obtained by subtracting voltage VS from voltage V0 which is a voltage at the start of discharging (when 0 seconds has elapsed from the start of discharging) was regarded as voltage drop amount ΔV at the start of discharging. Internal resistance (DCR) R₁ (Ω) of the electrochemical device was determined from formula (B) shown below using ΔV and a current value (current density per positive electrode area: 2 mA/cm²×positive electrode area) at the time of discharging.

Internal resistance R₁=ΔV/Id (B)

On the basis of R₁, power density P (kW/L) of the electrochemical device was evaluated by following formula (C).

P=(V₁−V₂)×V₂/(1,000×R₁×V_{CELL}) (C)

### [Evaluation 3: Measurement of Cycle Characteristics of Electrochemical Device]

Following charge 1 and discharge 1 were repeated 100,000 times. From the temporal change of the voltage in 100,000th discharge 1, capacitance C₁₀₀₀₀₀ of the electrochemical device after the cycle test was determined on the basis of above formula (A) in the same manner as for the derivation of initial capacitance C₁.

Under an environment of 25° C., the electrochemical device is subjected to constant current charging at a current density of 2 mA/cm² per positive electrode area until the voltage reached 3.8 V. Thereafter, a state in which a voltage of 3.8 V is applied is held for 10 minutes (charge 1).

Thereafter, under an environment of 25° C., constant current discharging is performed at a current density of 2 mA/cm² per positive electrode area until the voltage reached 2.2 V (discharge 1).

Change rate ΔC of capacitance C100000 from initial capacitance C1 was determined, and the cycle characteristics were evaluated by following formula (D). The results of the evaluation are shown in Table 1.

ΔC=((C₁₀₀₀₀₀/C₁)−1)×100 (D)

### (Devices A2 to A7, B1, B2)

The thickness of the copper foil as the negative current collector, the content proportion of the conductive additive (carbon black) in the negative electrode mixture slurry, and the specific surface area and the thickness on one side of the negative electrode mixture layer were changed as shown in Table 1. When the content proportion of the conductive additive in the negative electrode mixture slurry was changed, the content proportion of carboxycellulose as the binding agent was constant, and the content proportion of non-graphitizable carbon as the negative electrode active material was decreased (increased) as the content proportion of the conductive additive was increased (decreased).

Except for the above, devices A2 to A7, B1, B2 were produced and evaluated in the same manner as device A1. The results are shown in Table 1.

### (Devices B3, B4)

As a negative current collector, a perforated copper foil (opening ratio: 23%) provided with openings having a diameter of 0.075 mm was prepared.

In the production of an electrode body, an electrode body was formed by winding the positive electrode and the negative electrode not pre-doped in a columnar shape with a cellulose nonwoven fabric separator (with a thickness of 25 μm) interposed therebetween.

The electrode body was housed in a bottomed cell case with an opening together with a lithium piece, the tab lead connected to the positive current collection plate was connected to the inner surface of the sealing plate, and the negative current collection plate was welded to the inner bottom surface of the cell case. The nonaqueous electrolyte was put into the cell case, and then, the opening of the cell case was closed with the sealing plate. An electrochemical device as illustrated in FIG. 1 was thus assembled. The amount of lithium to be pre-doped was set such that the negative electrode potential in a nonaqueous electrolyte after the completion of pre-doping was less than or equal to 0.2 V with respect to metal lithium.

Except for the above, devices B3, B4 were assembled and evaluated in the same manner as device A1. However, in device B3, the thickness of the negative current collector was 8 μm, and in device B4, the thickness of the negative current collector was 20 μm. The results of the evaluation are shown in Table 1.

For each of devices A1 to A7, B1 to B4, the device after the initial charging and discharging was disassembled to take out the negative electrode, a half cell was produced using a reference electrode, which was a metal lithium foil, and a negative electrode, and the half cell was brought into contact with a nonaqueous electrolyte to measure the potential of the negative electrode with respect to the potential of the reference voltage. As a result, in all of devices A1 to A7, B1 to B4, the potential of the negative electrode was less than or equal to 0.2 V.

TABLE 1

| | Negative electrode | | | | | | | | | | |
|---|---|---|---|---|---|---|---|---|---|---|---|
| | | | | Mixture layer | | | | | Evaluation | | |
| | | | | Negative | Specific | Content | | | Initial | | Reliability |
| | Current collector | | | electrode | surface area | proportion | Specific | | characteristics | | Capacitance |
| | Through-hole | | | active | of conductive | of conductive | surface | Thickness | Power | Energy | change rate |
| | | Opening | Thickness | material | additive | additive | area | on one side | density | density | C₁₀₀₀₀₀/C₁ − 1 |
| | — | ratio | μm | — | m²/g | wt % | m²/g | μm | kW/L | Wh/L | % |
| A1 | Absent | 0 | 8 | Hard carbon | 800 | 5 | 40 | 32 | 12.9 | 13.1 | −5 |
| A2 | Absent | 0 | 8 | Hard carbon | 800 | 15 | 60 | 32 | 13.3 | 12.9 | −7 |
| A3 | Absent | 0 | 8 | Hard carbon | 800 | 3 | 30 | 32 | 12.7 | 13.1 | −5 |
| A4 | Absent | 0 | 10 | Hard carbon | 800 | 5 | 40 | 30 | 12.8 | 13 | −5 |
| A5 | Absent | 0 | 4 | Hard carbon | 800 | 5 | 40 | 36 | 12.6 | 13.3 | −5 |
| A6 | Absent | 0 | 15 | Hard carbon | 800 | 5 | 40 | 25 | 12.8 | 11.8 | −5 |
| A7 | Absent | 0 | 3 | Hard carbon | 800 | 5 | 40 | 32 | 11.9 | 13.6 | −5 |
| B1 | Absent | 0 | 8 | Hard carbon | 800 | 0.5 | 10 | 32 | 10.3 | 13.1 | −5 |
| B2 | Absent | 0 | 8 | Hard carbon | 800 | 20 | 120 | 32 | 13.5 | 12.8 | −23 |
| B3 | Present | 23 | 8 | Hard carbon | 800 | 5 | 40 | 32 | — | — | — |
| B4 | Present | 23 | 20 | Hard carbon | 800 | 5 | 40 | 32 | 9.5 | 11.2 | −5 |

From the comparison of devices A1 to A7, B1, B2, in devices A1 to A7 in which the negative current collector having no through-hole was used and the specific surface area of the negative electrode mixture layer was in the range from 30 m²/g to 60 m²/g, inclusive, a high energy density and a high power density could be maintained. In addition, the cycle characteristics are al so high.

In devices B3 and B4, since a perforated foil is used as the negative current collector, the strength of the negative current collector is low. In device B3 in which the thickness of the negative current collector was 8 μm, the negative electrode was broken during the production of the wound body, and an electrode body could not be obtained. In device B3 in which the thickness of the negative current collector was 20 μm, it was possible to form an electrode body, but both the energy density and the high power density decreased.

Further, graphite was used in place of non-graphitizable carbon (hard carbon) as a negative electrode active material, and an electrochemical device was produced in the same manner as device A1 except for this. In this case, in the charging and discharging cycle, the expansion and contraction were larger than those in the case of hard carbon, and the reliability was deteriorated.

### INDUSTRIAL APPLICABILITY

The electrochemical device according to the present invention is suitable for, for example, in-vehicle use.

### REFERENCE MARKS IN THE DRAWINGS

100 electrode body
10 positive electrode
11x positive current collector exposed part
13 positive current collection plate
15 tab lead
20 negative electrode
21x negative current collector exposed part
23 negative current collection plate
30 separator
200 electrochemical device
210 cell case
220 sealing plate
221 gasket

1. An electrochemical device comprising:
an electrode body including
a positive electrode,
a negative electrode, and
a separator disposed between the positive electrode and the negative electrode; and
an electrolyte containing a lithium salt, wherein:
the negative electrode includes a negative current collector and a negative electrode mixture layer supported on the negative current collector,
the negative electrode mixture layer contains a negative electrode active material that is reversibly doped with lithium ions,
the negative current collector has substantially no through-hole,
a specific surface area of the negative electrode mixture layer is in range from 30 m²/g to 60 m²/g, inclusive, and
in a discharged state, a potential of the negative electrode is less than or equal to 0.2 V with respect to a Li counter electrode.

2. The electrochemical device according to claim 1, wherein:
the negative electrode mixture layer contains a conductive additive, and
a content proportion of the conductive additive in the negative electrode mixture layer is in a range from 3% by mass to 15% by mass, inclusive.

3. The electrochemical device according to claim 1, wherein:
the negative electrode mixture layer contains a conductive additive, and
a specific surface area of the conductive additive is more than or equal to 800 m²/g.

4. The electrochemical device according to claim 2, wherein:
the negative electrode active material contains non-graphitizable carbon, and
the conductive additive contains carbon black.

5. The electrochemical device according to claim 1, wherein:
a thickness of the negative current collector is less than or equal to 15 μm, and
a thickness of the negative electrode mixture layer is more than or equal to 25 μm.

6. The electrochemical device according to claim 1, wherein the electrode body is a columnar wound body provided by winding the positive electrode having a band shape and the negative electrode having a band shape with the separator disposed between the positive electrode and the negative electrode.
